(19) United States
(12) Patent Application Publication
(10) Pub. No.: US 2022/0283301 A1
(43) Pub. Date: Sep. 8, 2022

(54) VEHICLE BODY STRUCTURE HAVING EXTERNAL ENVIRONMENT SENSOR

(71) Applicant: HONDA MOTOR CO., LTD., Tokyo (JP)

(72) Inventors: Yohei KURIHARA, Tokyo (JP); Kazuo SAKURAI, Tokyo (JP)

(21) Appl. No.: 17/580,726

(22) Filed: Jan. 21, 2022

(30) Foreign Application Priority Data
Mar. 8, 2021 (JP) 2021-035944

(51) Int. Cl. G01S 13/931; B60Q 9/00; G01S 7/02

(52) U.S. Cl. CPC G01S 13/931; B60Q 9/004; G01S 7/027

(57) ABSTRACT

A vehicle body structure having an external environment sensor includes: a vehicle body; and a sensor mount member supporting an external environment sensor and mounted on the vehicle body. The external environment sensor includes: a sensor main body that irradiates an electromagnetic wave to an object and receives a reflected wave from the object; and a housing accommodating the sensor main body, wherein a moth-eye structure is formed on an electromagnetic wave passing part of the housing through which at least one of the electromagnetic wave and the reflected wave passes.

### TECHNICAL FIELD

The present invention relates to a vehicle body structure having an external environment sensor for detecting objects around the vehicle.

### BACKGROUND ART

Conventionally, in a vehicle such as an automobile, an external environment sensor such as a millimeter wave radar is used to detect objects around the own vehicle. For example, a millimeter wave radar for object detection installed in an automobile is disposed at an appropriate part of the vehicle body such as a bumper or a front grill. When the millimeter wave radar is disposed on an exterior of the vehicle, if water, mud or the like adheres to the millimeter wave radar, the radio wave irradiated to objects or the reflected wave from the objects may be attenuated (namely, radar performance degradation may occur).

Therefore, to avoid the performance degradation of the millimeter wave radar installed in the vehicle in a situation where the vehicle may get wet such as when it is raining, for example, there is proposed a waterproof structure for a millimeter wave radar which includes a cover member that covers all sides (upper, lower, left, and right sides) of a radome of the millimeter wave radar excluding the irradiation direction of the radio wave (see JP2009-300390A).

In the above conventional technology, it is necessary to additionally install the cover member dedicated to the millimeter wave radar, and this leads to increase of the vehicle weight. On the other hand, suppression of performance degradation due to adhesion of water, mud or the like is important not only in the millimeter wave radar but also in any external environment sensor that uses an electromagnetic wave to detect objects.

### SUMMARY OF THE INVENTION

In view of the foregoing background, a primary object of the present invention is to provide a vehicle body structure that suppresses performance degradation of an external environment sensor due to adhesion of water, mud or the like while avoiding increase of the vehicle weight.

To achieve the above object, one aspect of the present invention provides a vehicle body structure having an external environment sensor (15), comprising: a vehicle body (3); and a sensor mount member (31) supporting an external environment sensor and mounted on the vehicle body, wherein the external environment sensor comprises: a sensor main body (25) that irradiates an electromagnetic wave to an object and receives a reflected wave from the object; and a housing (27) accommodating the sensor main body, wherein a moth-eye structure (43) is formed on an electromagnetic wave passing part of the housing through which at least one of the electromagnetic wave and the reflected wave passes.

According to this aspect, by forming a moth-eye structure having water-repellent or hydrophilic property on the electromagnetic wave passing part of the housing of the external environment sensor, it is possible to suppress the performance degradation of the external environment sensor due to adhesion of water, mud or the like while avoiding increase of the vehicle weight.

In the above aspect, preferably, the external environment sensor is a millimeter wave sensor (15), the moth-eye structure has multiple bumps (42) arranged on an uneven surface (141A), and an arrangement interval (L2) of multiple convex parts (142) of the uneven surface is greater than an arrangement interval (L1) of the multiple bumps.

According to this aspect, the uneven surface suppresses attenuation of the electromagnetic wave irradiated (transmitted) or received by the external environment sensor, and the multiple bumps give water-repellent or hydrophilic property to the electromagnetic wave passing part, whereby the performance degradation of the external environment sensor due to adhesion of water, mud or the like can be suppressed.

In the above aspect, preferably, the moth-eye structure is formed on a surface of a front wall (35, 135) of the housing, the front wall serving as the electromagnetic wave passing part.

According to this aspect, the moth-eye structure of the electromagnetic wave passing part can be realized with a simple configuration.

In the above aspect, preferably, the housing has a box-shaped sensor accommodating member (51) having an opening (50) in a front part thereof such that the electromagnetic wave and the reflected wave pass through the opening, and the front wall includes a film (135) that closes the opening.

According to this aspect, increase of the vehicle weight can be avoided more effectively.

In the above aspect, preferably, the vehicle body has a cover member (5, 13) which is disposed outside the external environment sensor and through which at least one of the electromagnetic wave and the reflected wave passes, and the moth-eye structure is formed on an inner surface of the cover member opposing the external environment sensor.

According to this aspect, by forming a moth-eye structure having water-repellent or hydrophilic property on the inner surface of the cover member opposing the external environment sensor, it is possible to suppress the performance degradation of the external environment sensor due to adhesion of water, mud or the like on the cover member while avoiding increase of the vehicle weight.

In the above aspect, preferably, the vehicle body has at least one of a bumper (5) and a front grill (13) as the cover member, and the moth-eye structure is formed on an inner surface of the bumper or the front grill opposing the external environment sensor.

According to this aspect, the performance degradation of the external environment sensor due to adhesion of water, mud or the like on the cover member can be suppressed with a simple configuration.

In the above aspect, preferably, the moth-eye structure is formed on at least a part of a side wall (36) of the housing.

According to this aspect, it is possible to prevent the water, mud or the like from adhering on the side wall of the housing and moving to the front wall (electromagnetic wave passing part).

According to the foregoing configuration, it is possible to provide a vehicle body structure that can suppress performance degradation of an external environment sensor due to adhesion of water, mud or the like while avoiding increase of the vehicle weight.

### BRIEF DESCRIPTION OF THE DRAWINGS

FIG. 1 is a perspective view showing a front portion of a vehicle provided with a vehicle body structure having a millimeter wave radar according to an embodiment of the present invention;

FIG. 2 is a sectional view the vehicle body structure around the millimeter wave radar;

FIG. 3 is a perspective view showing a schematic configuration of the millimeter wave radar;

FIG. 4A is a schematic sectional view showing one suitable example of a moth-eye structure;

FIG. 4B is a schematic sectional view showing another suitable example of a month-eye structure;

FIG. 5 is a sectional view showing a first modification of the vehicle body structure having the millimeter wave radar; and

FIG. 6 is a sectional view showing a second modification of the vehicle body structure having the millimeter wave radar.

### DETAILED DESCRIPTION OF THE INVENTION

In the following, a vehicle provided with a vehicle body structure having an external environment sensor according to an embodiment of the present invention will be described with reference to the drawings. In the present embodiment, description will be exemplarily made of a vehicle body structure of an automobile 1 as a vehicle, in which the vehicle body structure has a millimeter wave radar 15 as the external environment sensor.

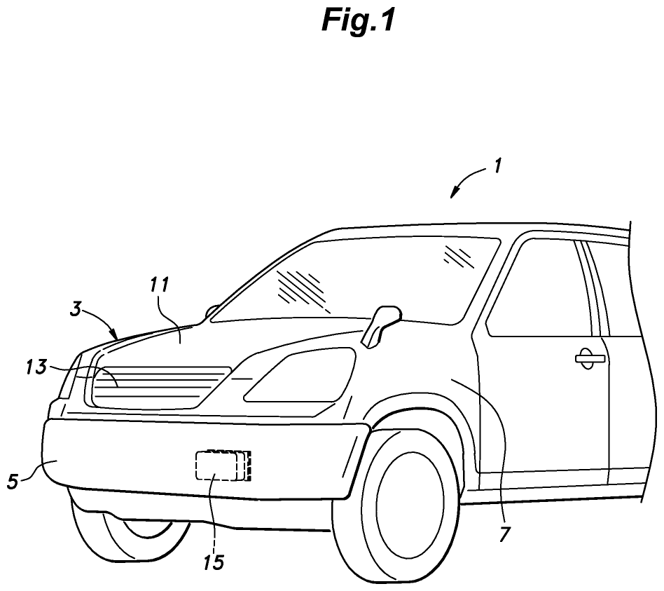

As shown in FIG. 1, the automobile 1 includes a vehicle body 3 that forms a basic skeleton thereof. An outer shell of a front portion of the vehicle body 3 is configured by a front bumper 5, left and right fender panels 7, an engine hood 11, a front grill 13, etc. Behind the front bumper 5, a millimeter wave radar 15 (millimeter wave sensor) serving as an external environment sensor is provided.

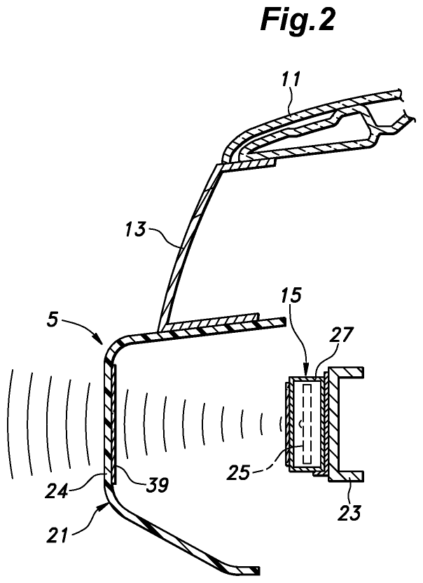

As shown in FIG. 2, the front bumper 5 includes a bumper face 21 forming an outer shell disposed to extend in the vehicle width direction and a support frame 23 that supports the millimeter wave radar 15 on a rear side (inner side) of the bumper face 21. Both end portions of the support frame 23 are attached to a vehicle body structural member (such as a front side frame) not shown in the drawings by bolt fastening or the like.

The bumper face 21 is configured by a member (for example, a resin member) through which the electromagnetic wave used by the external environment sensor (here, the millimeter wave radar 15) can pass. Note that in the front bumper 5, it is only required that at least a part 24 through which the transmission wave and the reception wave pass (hereinafter referred to as a center-facing part 24) is configured so as not to excessively obstruct passing of the radio wave by appropriate selection of the material of the constituent member thereof, painting, etc. A configuration in which the millimeter wave radar 15 is mounted in an opening formed in the bumper face 21 is also possible.

The millimeter wave radar 15 transmits (irradiates) a radio wave in a millimeter wave band (hereinafter referred to as the transmission wave) in a forward direction of the vehicle body 3 and receives the wave reflected by an object (target) present in front of the vehicle body 3 (hereinafter referred to as the reception wave). Thereby, the millimeter wave radar 15 measures the distance to the object, the angle to the object (the direction of the position of the object), and the velocity of the object from a time delay and/or a frequency change of the reception wave based on a known method. As the radio wave in the millimeter wave band, for example, a radio wave having a wavelength is in the order of millimeters (for example, 1 mm to 10 mm) and a frequency of about 30 GHz to 300 GHz (for example, 24, 60, 76, 79 GHz band) can be used. In transmission of the transmission wave of the millimeter wave radar 15, a frequency modulated continuous wave (FMCW) method may be used, for example.

Also, as shown in FIG. 2, the millimeter wave radar 15 includes a sensor main body 25 that irradiates the transmission wave to an object (not shown in the drawings) around the automobile 1 and receives the reflected wave from the object and a box-shaped housing 27 that accommodates the sensor main body 25. Though not illustrated in the drawings here, the sensor main body 25 includes known components such as an antenna for transmission, an antenna for reception, and a processor. The processor executes various calculations for detecting objects based on the data obtained from the reception wave.

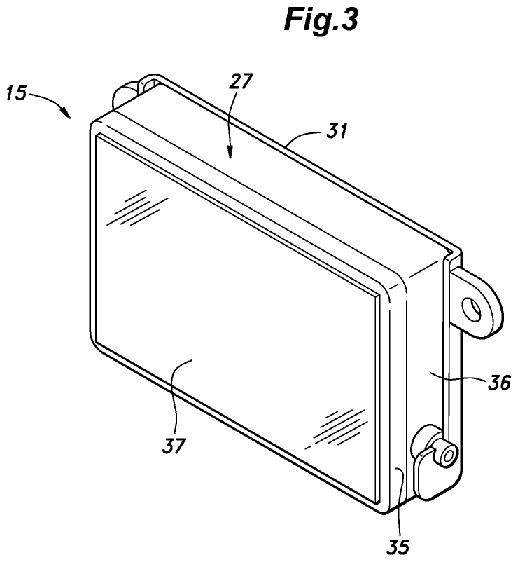

As best shown in FIG. 3, the millimeter wave radar 15 is provided with a sensor bracket (sensor mount member) 31 that supports the housing 27. The sensor bracket 31 is mounted on the support frame 23 while supporting the housing 27 (namely, the millimeter wave radar 15). Note that the sensor bracket 31 may be formed integrally with the housing 27. In other words, a part of the housing 27 may function as the sensor bracket (the sensor mount member).

In the housing 27, a moth-eye structure is formed on a part or an area through which at least one of the transmission wave and the reflected wave passes (hereinafter referred to as an electromagnetic wave passing part). In the present embodiment, a sensor protection film 37 formed with a moth-eye structure is attached (pasted) to a front wall 35 of the housing 27 that serves as the electromagnetic wave passing part. The front wall 35 is formed of a material having an excellent radio wave transparency (for example, polyphenylene sulfide (PPS) resin). The sensor protection film 37 is rectangular in shape as viewed from the front side of the housing 27 and is disposed to cover substantially the entirety of the front surface of the front wall 35.

Further, on the rear surface of the center-facing part 24 of the front bumper 5 (see FIG. 2), a bumper film 39 having the same structure as that of the sensor protection film 37 is attached. Note that the bumper film 39 is not necessarily indispensable, and may be omitted as the case may be.

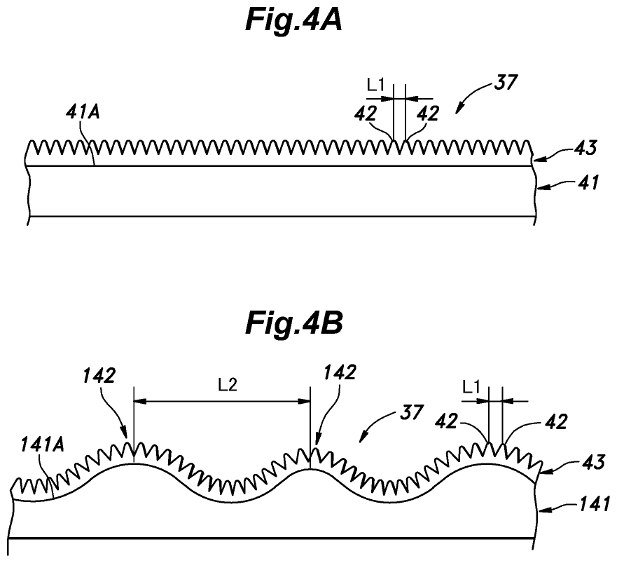

Next, with reference to FIGS. 4A and 4B, examples of the structure of the sensor protection film 37 will be described. FIG. 4A shows an example in which a moth-eye structure is formed on a flat surface, and FIG. 4B shows an example in which a moth-eye structure is formed on a surface having convex and concave parts (hereinafter referred to as an uneven surface).

As shown in FIG. 4A, for example, the sensor protection film 37 has a structure in which a moth-eye structure 43 having multiple bumps 42 (fine irregularities) is formed on a flat surface 41A of a base film 41 made of a transparent resin. In the present embodiment, arrangement is made such that the tip end portion of each bump 42 is directed substantially forward (transmission direction of the transmission wave). The thickness of the sensor protection film 37 is smaller than the thickness of at least the front wall 35. The multiple bumps 42 have nanometer-scale heights smaller than the wavelength of the radio wave in the millimeter wave band used as the transmission wave. An interval L1 of the multiple bumps 42 (distance between the tips of adjacent bumps) is set to 100 to 300 nm, for example.

As the manufacturing method of the sensor protection film 37, any known technology may be used. The base film 41 may be, for example, an acrylic film, a polyester film, a polycarbonate film, and the like. The material forming the moth-eye structure 43 may be, for example, a photocurable resin containing an epoxy-based resin, a urethane-based resin or the like mixed with a photopolymerization initiator, a radical generator, etc.

The moth-eye structure 43 may have water-repellent or hydrophilic property by selecting a resin component added to the material forming the moth-eye structure 43, for example (namely, characteristics of the resin component).

When the sensor protection film 37 (namely, the moth-eye structure 43) has water-repellent property, adhesion of water, mud or the like on the front wall 35 of the housing 27 (electromagnetic wave passing part) can be suppressed. As a result, the performance degradation of the millimeter wave radar 15 due to adhesion of water, mud or the like can be suppressed.

On the other hand, when the sensor protection film 37 has hydrophilic property, the mud, dust or the like adhering on the front wall 35 of the housing 27 can be washed away together with water. As a result, the performance degradation of the millimeter wave radar 15 due to adhesion of water, mud or the like can be suppressed.

Also, as shown in FIG. 4B, for example, the sensor protection film 37 may have a configuration in which the base film 41 is made of a transparent resin has an uneven surface 141A, on which the moth-eye structure 43 including the multiple bumps 42 is formed. Note that the configuration of the sensor protection film 37 of FIG. 4B is the same as that the aforementioned sensor protection film 37 of FIG. 4A, except for the features described below.

An interval L2 of convex parts 142 of the uneven surface 141A (distance between the tips of adjacent convex parts 142) is set greater than the interval L1 of the multiple bumps 42. The interval L2 of the convex parts 142 is 1,000 to 10,000 μm (1 to 10 mm), for example, and is greater than the interval L1 of the bumps 42 (for example, 100 to 300 nm).

The sensor protection film 37 shown in FIG. 4B provides advantages that the uneven surface 141A suppresses attenuation of the electromagnetic wave (here, the transmission wave or the reception wave) while the bumps 42 suppresses adhesion of water, mud or the like on the front wall 35 of the housing 27.

As described above, in the vehicle body structure according to the present embodiment, the moth-eye structure 43 having water-repellent or hydrophilic property is formed on the electromagnetic wave passing part of the housing 27 of the millimeter wave radar 15, whereby the performance degradation of the millimeter wave radar 15 due to adhesion of water, mud or the like can be suppressed while avoiding increase of the vehicle weight.

In the above-described example, the moth-eye structure 43 was formed on the front wall 35 (electromagnetic wave passing part) of the housing 27, but the present invention is not limited to this, and a similar moth-eye structure may be formed on a part around the electromagnetic wave passing part. For example, the moth-eye structure may be formed on at least a part of a surface of a side wall 36 of the housing 27 (see FIG. 3). Thereby, it is possible to prevent the water, mud or the like from adhering on the side wall 36 of the housing 27 and moving to the front wall 35 (the electromagnetic wave passing part). Similarly, the moth-eye structure may be formed on at least a part of the surface of the sensor bracket 31.

Note that the bumper film 39 may be configured similarly to the sensor protection film 37 shown in FIGS. 4A and 4B.

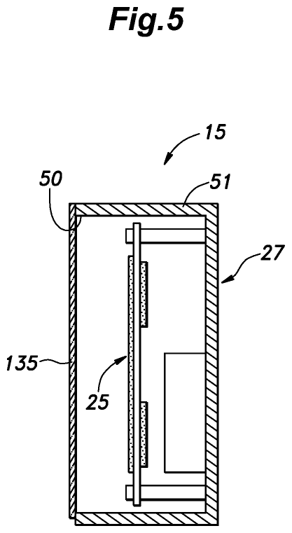

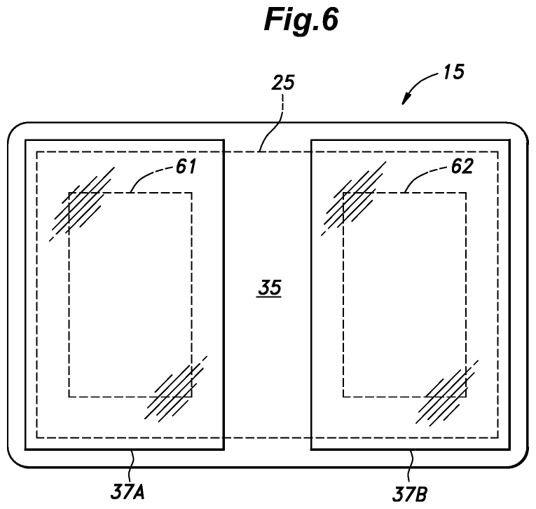

Next, with reference to FIG. 5 and FIG. 6, first and second modifications of the vehicle body structure having the millimeter wave radar 15 will be described.

In the above-described example, the sensor protection film 37 was attached to the front wall 35 of the housing 27 of the millimeter wave radar 15. In the first modification, a sensor protection film 135 similar to the sensor protection film 37 is used as the front wall 35 of the housing 27.

More specifically, as shown in FIG. 5, in the first modification, the housing 27 of the millimeter wave radar 15 includes a box-shaped sensor accommodating member 51 having an opening 50 in a front part thereof through which the transmission wave and the reception wave pass. Also, a front wall that closes the opening 50 of the sensor accommodating member 51 is formed by the sensor protection film 135 having a moth-eye structure.

According to the first modification, the sensor protection film 135 formed with a moth-eye structure is used as the front wall of the housing 27 so that, compared to the above-described configuration in which the sensor protection film 37 is attached to the front wall 35, increase of the vehicle weight can be avoided more effectively. Note that the thickness of the base film of the sensor protection film 135 may be set greater than that of the base film of the sensor protection film 37.

In the structure shown in FIG. 5, the entirety of the front side of the sensor accommodating member 51 is opened by the opening 50. However, the present invention is not limited to this and configuration may be made such that a part of the front wall 35 of the housing 27 shown in FIG. 3 (the electromagnetic wave passing part) is formed with a smaller opening and the opening is closed by the sensor protection film 135, for example.

Also, in the above-described example, the sensor protection film 37 was attached to the substantially entirety of the front surface of the front wall 35 of the housing 27 of the millimeter wave radar 15. In the second modification, two sensor protection films 37A, 37B similar to the sensor protection film 37 are attached to parts of the front wall 35 of the housing 27.

More specifically, in the second modification, the sensor protection films 37A, 37B are disposed in front of a transmission antenna 61 and a reception antenna 63, respectively, as shown in FIG. 6.

According to the second modification, the multiple sensor protection films 37A, 37B each formed with a moth-eye structure are disposed only on necessary parts (radio wave passing parts) of the housing 27, and therefore, compared to the above-described configuration in which the sensor protection film 37 is attached to the substantially entirety of the front surface of the front wall 35, the configuration can be simpler.

Concrete embodiments of the present invention have been described in the foregoing, but the present invention is not limited to the above embodiments and may be modified or altered in various ways.

For example, the vehicle body structure having an external environment sensor according to the present invention is not limited to the automobile 1, and is applicable to any moving body (for example, a mobile robot) that can function as a vehicle. Also, the external environment sensor regarding the present invention is not limited to the millimeter wave radar 15, and may be utilized as any sensor using an electromagnetic wave (an infrared sensor, a radar sensor, etc.). Further, the position of the external environment sensor regarding the present invention is not limited to behind the front bumper 5, and the external environment sensor may be disposed on a rear (or inner) side of another configuration member (for example, the front grill 13) of the automobile 1.

1. A vehicle body structure having an external environment sensor, comprising:
a vehicle body; and
a sensor mount member supporting an external environment sensor and mounted on the vehicle body,
wherein the external environment sensor comprises:
a sensor main body that irradiates an electromagnetic wave to an object and receives a reflected wave from the object; and
a housing accommodating the sensor main body,
wherein a moth-eye structure is formed on an electromagnetic wave passing part of the housing through which at least one of the electromagnetic wave and the reflected wave passes.

2. The vehicle body structure according to claim 1, wherein the external environment sensor is a millimeter wave sensor,
the moth-eye structure has multiple bumps arranged on an uneven surface, and
an arrangement interval of multiple convex parts of the uneven surface is greater than an arrangement interval of the multiple bumps.

3. The vehicle body structure according to claim 1, wherein the moth-eye structure is formed on a surface of a front wall of the housing, the front wall serving as the electromagnetic wave passing part.

4. The vehicle body structure according to claim 3, wherein the housing has a box-shaped sensor accommodating member having an opening in a front part thereof such that the electromagnetic wave and the reflected wave pass through the opening, and
the front wall includes a film that closes the opening.

5. The vehicle body structure according to claim 1, wherein the vehicle body has a cover member which is disposed outside the external environment sensor and through which at least one of the electromagnetic wave and the reflected wave passes, and
the moth-eye structure is formed on an inner surface of the cover member opposing the external environment sensor.

6. The vehicle body structure according to claim 5, wherein the vehicle body has at least one of a bumper and a front grill as the cover member, and
the moth-eye structure is formed on an inner surface of the bumper or the front grill opposing the external environment sensor.

7. The vehicle body structure according to claim 1, wherein the moth-eye structure is formed on at least a part of a side wall of the housing.
